(19) United States
(12) Patent Application Publication
(10) Pub. No.: US 2025/0341464 A1
(43) Pub. Date: Nov. 6, 2025

(54) GAS SENSOR

(71) Applicant: Mitsubishi Electric Corporation, Tokyo (JP)

(72) Inventor: Kiyotomo HASEGAWA, Tokyo (JP)

(73) Assignee: Mitsubishi Electric Corporation, Tokyo (JP)

(21) Appl. No.: 18/871,758

(22) PCT Filed: Nov. 7, 2022
(86) PCT No.: PCT/JP2022/041407

§ 371 Date: Dec. 4, 2024

(51) Int. Cl. G01N 21/39

(52) U.S. Cl. CPC G01N 21/39

(57) ABSTRACT

A plurality of resonators (4a,4b,4c) having different resonator lengths simultaneously generate a plurality of laser beams having different wavelengths from light emitted from one gain medium (3). A light-receiving device (9a,9b,9c) detects the plurality of laser beams. The plurality of laser beams are caused to interfere with a determination-target gas (10) inside the plurality of resonators (4a,4b,4c).

### FIELD

The present disclosure relates to a gas sensor.

### BACKGROUND

Gas molecules have photo-absorption spectra at specific wavelengths. Therefore, the determination of the type of gas has been made by causing the gas to interfere with a laser beam that exhibits a sharp spectrum having a narrow linewidth and detecting absorption of the laser beam into the gas (see PTL 1, for example).

### CITATION LIST

### Patent Literature

[PTL 1] JP 3304846 B2

### SUMMARY OF THE INVENTION

### Problems to be Solved by the Invention

In a conventional gas sensor, a plurality of lasers that exhibit different oscillation wavelengths are used so that various types of gases can be determined. Therefore, there has been a problem that the gas sensor is increased in size. In addition, there has also been a problem that the cost increases because the lasers are expensive.

The present disclosure has been made to solve the above-described problems, and an object thereof is to obtain a small-sized and low-cost gas sensor.

### Solution to Problem

A gas sensor according to the present disclosure includes: one gain medium; a plurality of resonators having different resonator lengths and simultaneously generating a plurality of laser beams having different wavelengths from light emitted from the gain medium; and a light-receiving device detecting the plurality of laser beams, wherein the plurality of laser beams are caused to interfere with a determination-target gas inside the plurality of resonators.

### Advantageous Effects of Invention

In the present disclosure, the plurality of resonators having different resonator lengths are employed, so that laser beams having a plurality of wavelengths can be obtained even with a single gain medium. The plurality of laser beams are caused to interfere with the determination-target gas on the inside of the plurality of resonators so that the absorption of the plurality of laser beams by the determination-target gas is detected, and thereby a plurality of gas types can be determined. Only one expensive gain medium, and only one set of components including a power supply circuit for driving the gain medium and the like are needed, and therefore a small-sized and low-cost gas sensor can be achieved.

### BRIEF DESCRIPTION OF THE DRAWINGS

FIG. 1 is a view illustrating a gas sensor according to a first embodiment.

FIG. 2 is a diagram showing absorption spectra of major gases.

FIG. 3 a diagram showing an absorption spectrum of methane gas extracted out of FIG. 2.

FIG. 4 is a view illustrating a gas sensor according to a second embodiment.

FIG. 5 is a view illustrating a gas sensor according to a third embodiment.

FIG. 6 is a view illustrating a modification of the gas sensor according to the third embodiment.

FIG. 7 is a view illustrating a gas sensor according to a fourth embodiment.

FIG. 8 is a diagram showing the intensity of light detected by a light-receiving device.

### DESCRIPTION OF EMBODIMENTS

A gas sensor according to the embodiments of the present disclosure will be described with reference to the drawings. The same components will be denoted by the same symbols, and the repeated description thereof may be omitted.

### First Embodiment

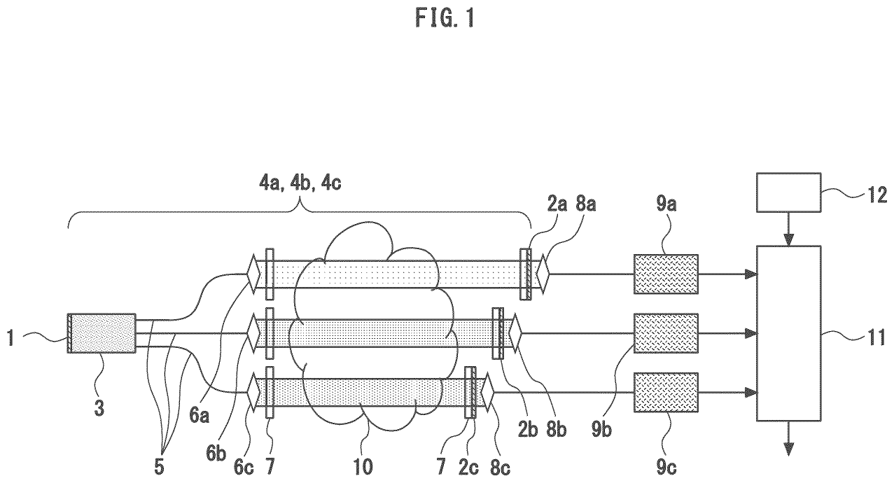

FIG. 1 is a view illustrating a gas sensor according to a first embodiment. One gain medium 3 is positioned between one mirror 1 and a plurality of semi-transmissive mirrors 2a, 2b, and 2c. The mirror 1 and the semi-transmissive mirror 2a are set to face each other to constitute a resonator 4a. Similarly, the mirror 1 and the semi-transmissive mirror 2b constitute a resonator 4b, and the mirror 1 and the semi-transmissive mirror 2c constitute a resonator 4c. Note that the distances between the mirror 1 and the respective semi-transmissive mirrors 2a, 2b, and 2c differ from each other. Hence, the mirror 1 and the plurality of semi-transmissive mirrors 2a, 2b, and 2c constitute a plurality of resonators 4a, 4b, and 4c having different resonator lengths.

The gain medium 3 is a semiconductor optical amplifier, Er doped fiber, or the like which amplifies the intensity of light passing therethrough. When a voltage is applied to the gain medium 3, broad natural light having a broad range of wavelengths is emitted. Optical waveguides 5 cause the light emitted from the gain medium 3 to branch into a plurality of light beams. Each of the optical waveguides 5 is an optical fiber or the like, and may be a waveguide formed on a substrate made of Si or SiO₂. The optical waveguides 5 and the gain medium 3 may be directly connected, or alternatively, a lens, a multimode interferometer (MMI) coupler, or the like may be introduced therebetween. The light beams emitted from the optical waveguides 5 into the air have a certain angle due to the difference in refractive index. Therefore, lenses 6a, 6b, and 6c serve to convert the plurality of light beams emitted from the optical waveguides 5 into collimated parallel light beams, and provide the collimated light beams to the plurality of resonators 4a, 4b, and 4c, respectively.

When broad light is introduced into a resonator, a laser beam having a wavelength according to the resonator length is generated. Accordingly, the plurality of resonators 4a, 4b, and 4c having different resonator lengths simultaneously generate a plurality of laser beams having different wavelengths from the light emitted from the gain medium 3. Each of the laser beams is a laser beam that exhibits a sharp spectrum having a narrow linewidth. Note that in the case where the resonator lengths are almost the same and oscillation wavelengths are similar to each other, interference may occur and stable laser beams cannot be obtained in some cases.

A gas cell 7 made of transparent glass or the like is inserted inside the plurality of resonators 4a, 4b, and 4c. The optical system including the gain medium 3, the resonators 4a, 4b, and 4c, the lenses 6a, 6b, and 6c and the like is airtightly sealed in a case, whereas the inner side of the gas cell 7 is exposed to the outside. Note that the lenses 6a, 6b, and 6c and lenses 8a, 8b, and 8c each may function as a partition for the gas cell 7. Windows or the like of the resonators 4a, 4b, and 4c may function as two parallel surfaces of the gas cell 7.

The lenses 8a, 8b, and 8c cause a plurality of laser beams passing through the semi-transmissive mirrors 2a, 2b, and 2c to converge on incident surfaces of light-receiving devices 9a, 9b, and 9c, respectively. Note that in the case where optical waveguides are provided in front of the light-receiving devices 9a, 9b, and 9c, the lenses 6a, 6b, and 6c adjust the beam diameters and cause the light to converge on the optical waveguides. Each of the light-receiving devices 9a, 9b, and 9c detects a corresponding one of the plurality of laser beams.

A determination-target gas 10 is provided to the gas cell 7, and the plurality of laser beams are caused to interfere with the determination-target gas 10 on the inner side of the resonators 4a, 4b, and 4c. When the determination-target gas 10 contains a gas component that has an absorption spectrum according to the wavelength of the laser beam, the intensity of the laser beam decreases.

A detector 11 detects the absorption of the plurality of laser beams by the determination-target gas 10 on the basis of the output from the light-receiving devices 9a, 9b, and 9c, thereby determining the type and concentration of the determination-target gas 10. Specifically, the gas type is determined on the basis of the wavelength of the laser beam that has decreased in intensity, and the gas concentration is determined on the basis of the amount of change in intensity of the laser beam.

The intensities of the laser beams having a plurality of wavelengths are detected by the photoreceivers in the state where the gas cell 7 is filled with the air introduced thereto without any determination-target gas 10. The result of detection by the light-receiving devices 9a, 9b, and 9c is stored in advance in a storage 12 as reference data. The detector 11 compares the result of detection by the light-receiving devices 9a, 9b, and 9c to the reference data, thereby determining the type and concentration of the determination-target gas 10. Otherwise, a standard sample the gas type and gas concentration of which are known may be used to detect the intensities of the laser beams and record the result of detection as reference data. In this case, the intensities of the laser beams detected while the determination-target gas 10 is introduced into the sensor are compared to the reference data, thereby calculating the gas type and gas concentration.

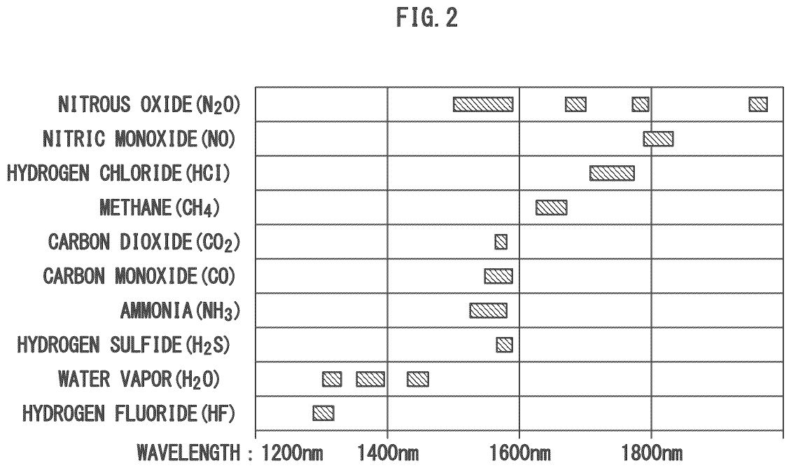

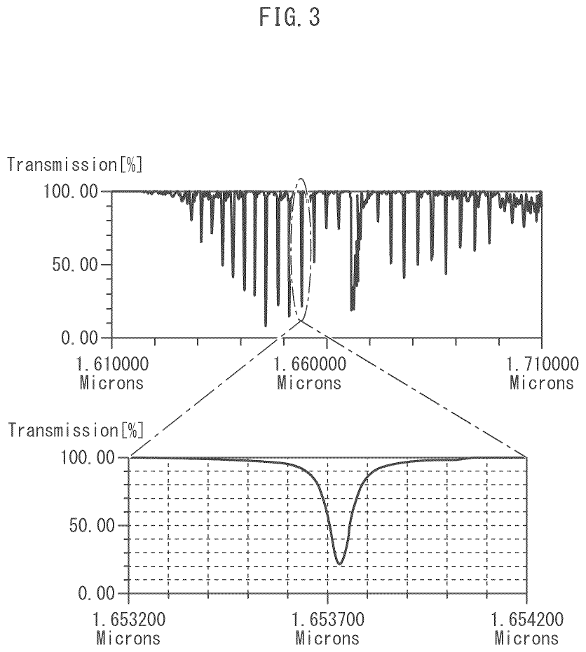

FIG. 2 is a diagram showing absorption spectra of major gases. FIG. 3 a diagram showing an absorption spectrum of methane gas extracted out of FIG. 2. While FIG. 2 shows general bands where the absorption spectra exist, a plurality of small absorption spectra actually exist within each band as shown in FIG. 3.

As described above, the plurality of resonators 4a, 4b, and 4c having different resonator lengths are employed in the present embodiment, so that laser beams having a plurality of wavelengths can be obtained even with a single gain medium 3. The plurality of laser beams are caused to interfere with the determination-target gas 10 on the inside of the plurality of resonators 4a, 4b, and 4c so that the absorption of the plurality of laser beams by the determination-target gas 10 is detected, and thereby a plurality of gas types can be determined. Only one expensive gain medium 3, and only one set of components including a power supply circuit for driving the gain medium 3 and the like are needed, and therefore a small-sized and low-cost gas sensor can be achieved.

For example, the gas sensor according to the present embodiment may be used as an odor sensor or the like. The resonator lengths of the resonators 4a, 4b, and 4c are set such that a laser beam having a wavelength according to the detection-target gas is generated. In the case where three resonators 4a, 4b, and 4c are used, three types of gases such as ammonia, carbon dioxide, and nitrous oxide, for example, can be detected. In the case where five types of gases further including methane and hydrogen chloride are to be detected, five resonators are used.

The oscillation wavelength of the laser beam is defined by the resonator length and the refractive index of an optical path, but in a precise sense, the refractive index varies depending on the type and concentration of the gas in the optical path, and the oscillation wavelength slightly varies accordingly. However, since gas detection in daily life is assumed, the influence of this is not expected to be particularly significant. In the case of detecting a high-concentration gas, the gas concentration can be accurately detected by employing a peak search by means of wavelength scanning in combination.

### Second Embodiment

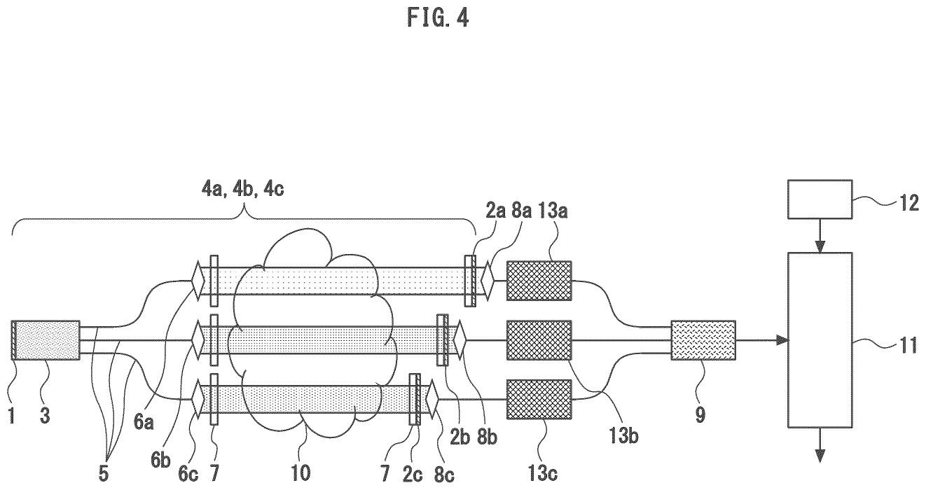

FIG. 4 is a view illustrating a gas sensor according to a second embodiment. Light switches 13a, 13b, and 13c switch to allow incident light to pass therethrough or not. Laser beams having different wavelengths coming out of three resonators 4a, 4b, and 4c are sequentially caused to pass through the light switches 13a, 13b, and 13c, respectively, to be incident on one light-receiving device 9. That is, the gas type identification is performed in a time division manner. This can reduce the number of light-receiving devices 9. The other components and effects are similar to those of the first embodiment.

### Third Embodiment

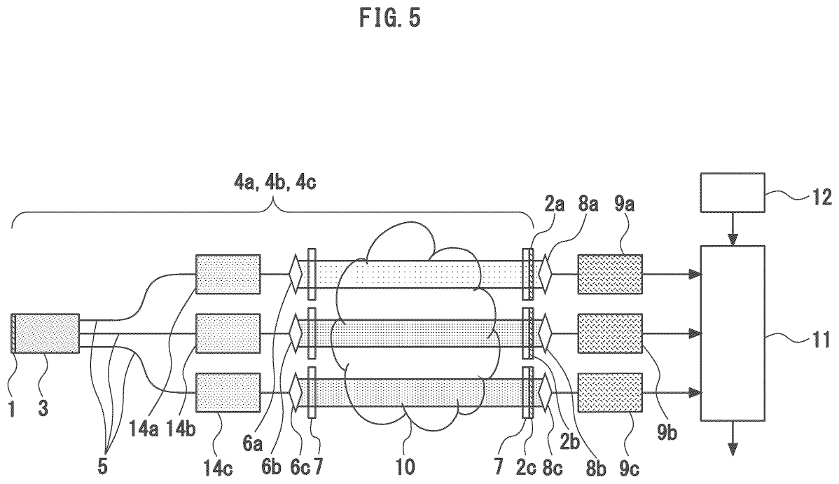

FIG. 5 is a view illustrating a gas sensor according to a third embodiment. The distances between a mirror 1 and a plurality of semi-transmissive mirrors 2a, 2b, and 2c are the same. A plurality of delay units 14a, 14b, and 14c are provided in a plurality of resonators 4a, 4b, and 4c, respectively. The delay units 14a, 14b, and 14c have different refractive indices.

The delay units 14a, 14b, and 14c are devices used for signal modulation in optical communication, and are composed of LiNbO₃ being an insulating material, or InP, Si or the like being a semiconductor. A delay unit composed of LiNbO₃ adjusts the refractive index by means of the Pockels effect induced by voltage application. A delay unit composed of InP or Si adjusts the refractive index by means of the thermo-optic effect or the carrier plasma effect induced by current flow.

The velocity of light varies depending on the refractive index. Accordingly, the change in refractive index causes a change in practical resonator length with respect to the laser beam, leading to a change in oscillation wavelength. Consequently, since the plurality of resonators 4a, 4b, and 4c have different resonator lengths, a plurality of laser beams having different wavelengths can be simultaneously generated from the light emitted from a gain medium 3. The other components are similar to those of the first embodiment, and effects similar to those of the first embodiment can be obtained.

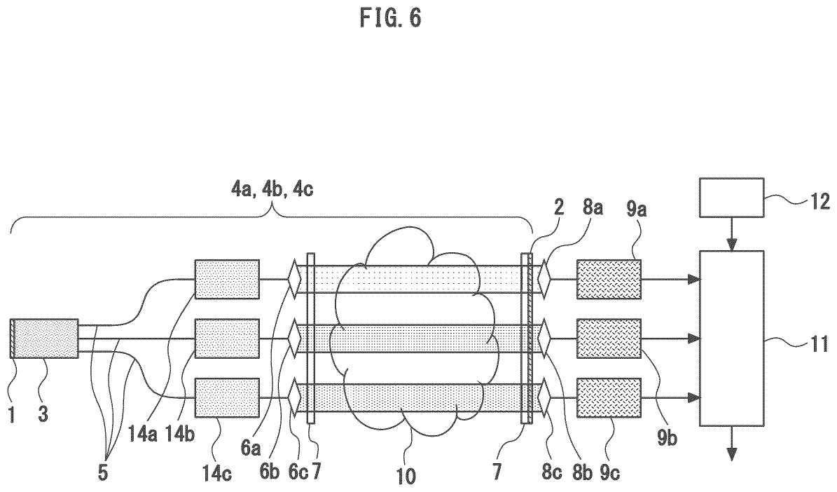

FIG. 6 is a view illustrating a modification of the gas sensor according to the third embodiment. In the configuration illustrated in FIG. 5, the positions of the plurality of semi-transmissive mirrors 2a, 2b, and 2c are moved to roughly match a target oscillation wavelength, and then fine adjustment is made by means of the delay units 14a, 14b, and 14c, thereby enhancing the resolution. On the other hand, delay units 14a, 14b, and 14c of the configuration illustrated in FIG. 6 exhibit enough dynamic ranges and resolutions. In this case, the oscillation wavelength can be controlled by the delay units 14a, 14b, and 14c, thereby eliminating the necessity of controlling the oscillation wavelength by the positions of the semi-transmissive mirrors. Therefore, one semi-transmissive mirror 2 suffices, regardless of the number of wavelengths of the laser beams to be dealt with. That is, the one mirror 1 and the one semi-transmissive mirror 2 facing each other are shared among the plurality of resonators 4a, 4b, and 4c.

### Fourth Embodiment

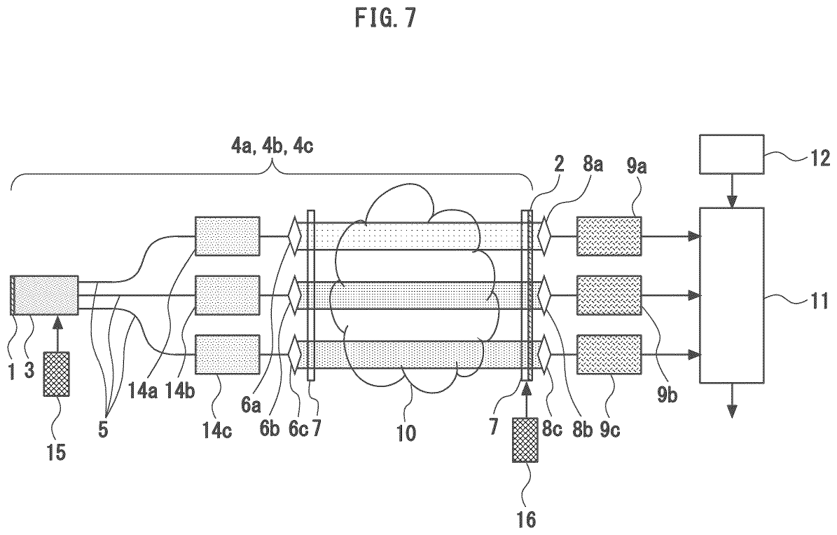

FIG. 7 is a view illustrating a gas sensor according to a fourth embodiment. A temperature adjustment unit 15 adjusts the temperature of a gain medium 3 in order to adjust the refractive index of the gain medium 3. In the case where the gain medium 3 is a semiconductor optical amplifier, the temperature adjustment 15 may be a Peltier device, or a current source for temperature adjustment which utilizes self-heating of the semiconductor optical amplifier, for example. A position adjustment unit 16 is a Piezoelectric device or MEMS which physically moves the semi-transmissive mirror 2 to adjust the position of the semi-transmissive mirror 2. Note that the position adjustment unit 16 may be configured to individually adjust the position of each of the semi-transmissive mirrors 2a, 2b, and 2c. The other components are similar to those of the first to third embodiments.

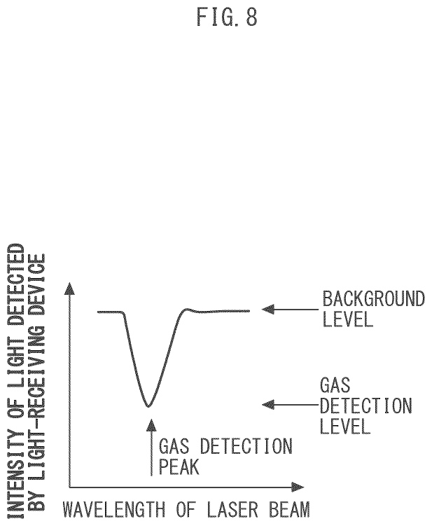

FIG. 8 is a diagram showing the intensity of light detected by a light-receiving device. The difference is detected between a gas detection peak generated by absorption of a laser beam by a determination-target gas 10 and a background level of a sensor including a stain or deterioration over time. In addition, the temperature of the gain medium 3 is adjusted so that the range of oscillation wavelengths needed is defined. The positions of the semi-transmissive mirrors 2, 2a, 2b, and 2c are adjusted so that the laser beam is operated in the range of absorption spectra of the determination-target gas 10. The delay units 14a, 14b, and 14c are adjusted so that the oscillation wavelength of each of the resonators 4a, 4b, and 4c is set individually. The oscillation wavelengths of the resonators 4a, 4b, and 4c are scanned while the temperature of the gain medium 3, the positions of the semi-transmissive mirrors 2, 2a, 2b, and 2c, or the refractive indices of the delay units 14a, 14b, and 14c are adjusted as described above, and thereby the accuracy of gas detection can be enhanced.

Reference Signs List

1 mirror; 2 semi-transmissive mirror;
3 gain medium; 4a, 4b, 4c resonator;
5 optical waveguide;
6a, 6b, 6c lens; 9, 9a, 9b, 9c light-
receiving device; 11 detector; 12 storage;
13a, 13b, 13c light switch;
14a, 14b, 14c delay unit; 15 temperature
adjustment unit; 16 position adjustment unit

1. A gas sensor comprising:
one gain medium;
a plurality of resonators having different resonator lengths and simultaneously generating a plurality of laser beams having different wavelengths from light emitted from the gain medium; and
a light-receiving device detecting the plurality of laser beams,
wherein the plurality of laser beams are caused to interfere with a determination-target gas inside the plurality of resonators.

2. The gas sensor according to claim 1, further comprising a detector detecting an absorption of the plurality of laser beams by the determination-target gas based on an output of the light-receiving device to determine type of the determination-target gas.

3. The gas sensor according to claim 2, further comprising a storage storing reference data,
wherein the detector compares a result of detection by the light-receiving device to the reference data to determine type or concentration of the determination-target gas.

4. The gas sensor according to claim 1, further comprising an optical waveguide causing light emitted from the gain medium to branch into a plurality of light beams, and
a lens serving to convert the plurality of light beams into collimated parallel light beams, and providing the collimated light beams to the plurality of resonators respectively.

5. The gas sensor according to claim 1, further comprising a light switch sequentially causing laser beams coming out of the plurality of resonators to be incident on the light-receiving device.

6. The gas sensor according to claim 1, further comprising a plurality of delay units provided in the plurality of resonators respectively and having different refractive indices.

7. The gas sensor according to claim 6, wherein one mirror and one semi-transmissive mirror facing each other are shared among the plurality of resonators.

8. The gas sensor according to claim 1, further comprising a temperature adjustment unit adjusting temperature of the gain medium, and
a position adjustment unit adjusting positions of mirrors of the plurality of resonators.
